(19) United States
(12) Patent Application Publication
(10) Pub. No.: US 2023/0161646 A1
(43) Pub. Date: May 25, 2023

(54) EVENT MANAGEMENT METHOD AND CORRESPONDING INTEGRATED CIRCUIT

(71) Applicants: STMicroelectronics (Grenoble 2) SAS, Grenoble (FR); STMicroelectronics (Rousset) SAS, Rousset (FR)

(72) Inventors: Isabelle Carnel, Presles (FR); Valerie Assemat, Champagnier (FR); Edwin Hilkens, Coublevie (FR); Jeremy Ribeiro De Freitas, Coublevie (FR); Jean Claude Bini, Tourrettes-sur-loup (FR)

(21) Appl. No.: 18/058,648

(22) Filed: Nov. 23, 2022

(30) Foreign Application Priority Data
Nov. 25, 2021 (FR) 2112538

(51) Int. Cl. G06F 9/54; G06F 9/48

(52) U.S. Cl. CPC G06F 9/542; G06F 9/4881

(57) ABSTRACT

In an embodiment an integrated circuit includes a digital-signal processing unit having an event management device configured to associate respective event data items with respective trigger signals and a digital-signal processor configured to associate a respective task with an respective event data item, wherein the event management device is configured to receive the trigger signals at input terminals and, when a trigger signal is received, store the event data item associated with the received trigger signal in an event register, and wherein the digital-signal processor is configured execute the task associated with the event data item stored in the event register.

### CROSS-REFERENCE TO RELATED APPLICATIONS

This application claims the benefit of French Application No. 2112538, filed on Nov. 25, 2021, which application is hereby incorporated herein by reference.

### TECHNICAL FIELD

Embodiments and implementations relate to event management, such as receptions of trigger signals, in particular in the context of a digital-signal processing unit.

### BACKGROUND

The term “events,” in reaction to a reception of trigger signals, corresponds typically to the case where the receiver device, for example, digital-signal processing unit, is designed to have a waiting-for-event state able to react immediately to the reception of a trigger signal. The waiting-for-event state is typically provided between two task executions.

Events are in particular distinguished from interruptions, which also occur in reaction to a reception of “interrupt” signals, and which typically interrupt the execution of a current task of the receiving device. Context transition mechanisms are typically used in order to save the current work and the context of the execution, at the moment of the interruption.

Moreover, management of events and interruptions typically uses logic interpretation mechanisms (“interpreters”) configured for analysing the event or the interruption received in order to implement the required action. Typically, the interpretation may comprise in particular a decoding of the content of the trigger signal or of the interruption so as to identify a command, or an identification of the device that generated the trigger signal or the interruption, so as to take into consideration its access rights or the priority of its command.

The conventional techniques thus make it possible to benefit from a flexibility of applications, with varied commands, but have the drawback of having a reactivity delayed by the context transition mechanisms, and by the interpretation mechanisms.

However, in certain applications sensitive to reactivity, the reaction delays introduced by the conventional techniques may exceed the reaction time imposed by the application.

For example, motor commands are applications sensitive to reactivity, for which the maximum reaction time may be of the order of 15 clock cycles for a task performed by a digital-signal processing unit.

### SUMMARY

According to one embodiment, in this regard an integrated circuit is proposed including a digital-signal processing unit comprising an event management device configured for associating respective event data items with respective trigger signals, and a digital-signal processor configured for associating a respective task with each event data item, the event management device being adapted for receiving the trigger signals on input terminals, and, when a trigger signal is received, for storing in an event register the event data item associated with the trigger signal received, the digital-signal processor being configured for executing the task associated with the event data item stored in the event register.

For example, the event management device is configured for associating respective event data items with respective trigger signals by means of a look-up table, i.e. a list associating event data items with each trigger signal and the respective input terminal. For example, the digital-signal processor is configured for associating a respective task with each event data item by software, i.e. by a program providing the executions respectively associated with each event data item.

Thus, in other words, the device according includes an event management device configured for reacting to a stimulus (i.e. a reception of a trigger signal) and preparing a corresponding event data item, so that the digital-signal processor can immediately execute the task associated with the event associated with the stimulus.

Consequently, the reaction time for performing the task on reception of the trigger signal does not include a context transition phase, or a phase of analysing and interpreting the command.

The associations between the event data items and the trigger signals, as well as between the tasks and the event data, advantageously being provided in advance, the reaction time can correspond to the time of a consultation operation (for example consulting the look-up table and the event register) and is almost zero.

According to one embodiment, the digital-signal processor is configured for executing said task if the digital-signal processor is in a waiting-for-event state.

The waiting-for-event state is for example activated at the end of an execution of a task by the digital-signal processor. This corresponds to an implementation wherein the tasks currently being processed are not interrupted.

Thus, for example if the trigger signal is received during a processing operation, at the moment when the digital-signal processor enters the waiting-for-event state, the event data item has already been stored in the event register by the event management device. The digital-signal processor can thus react immediately, without carrying out any analysis.

According to one embodiment, the event management device is adapted for being parameterised during an initialisation phase, by an external command defining the associations between the event data and the trigger signals.

The external command comes for example from a master device, such as a host processor of a system on chip or of a microcontroller.

According to one embodiment, the digital-signal processor is configured by software for associating the respective task with each event data item, and for executing said tasks.

Thus the event management device is flexible and configurable by a user, for example according to the circumstances of use of various trigger signals and various tasks to be executed in reaction thereto.

According to one embodiment, the event management device is configured for hierarchising the event data in order of priority, so that an event data item of higher priority can replace an event data item of lower priority in the event register, while an event data item of lower priority cannot replace an event data item of higher priority in the event register.

According to another embodiment, an event management method is proposed, in a signal processing unit, comprising an association of respective event data items with trigger signals that can be received on input terminals and an association of respective tasks with the event data items, the method comprising a reception of a trigger signal on an input terminal, a storage of the event data item associated with the trigger signal received in an event register, and an execution of the task associated with the event data item stored in the event register.

According to one embodiment, the storage of said event data item in the event register is done in response to the reception of said trigger signal, and said task is executed if a digital-signal processor of said signal processing unit is in a waiting-for-event state.

According to one embodiment, the association of respective event data items with the trigger signals is parameterised during an initialisation phase, by an external command defining said associations between the event data items and the trigger signals.

According to one embodiment, the association of respective tasks with the event data items, and the execution of the task associated with the event data item stored in the event register, are configured by software in a digital-signal processor.

According to one embodiment, the event data items are hierarchised by order of priority, so that an event data item with a higher priority can replace an event data item of lower priority in the event register, while an event data item of lower priority cannot replace an event data item of higher priority in the event register.

### BRIEF DESCRIPTION OF THE DRAWINGS

Other advantages and features of the invention will emerge from the examination of the detailed description of embodiments and implementations, which are in no way limitative, and the accompanying drawings, in which:

FIG. 1 illustrates an integrated circuit according to an embodiment;

FIG. 2 illustrates schematically a list of associations between trigger signals and event data items, and between the event data items and tasks according to embodiments; and

FIG. 3 illustrates an event management method according to embodiments.

### DETAILED DESCRIPTION OF ILLUSTRATIVE EMBODIMENTS

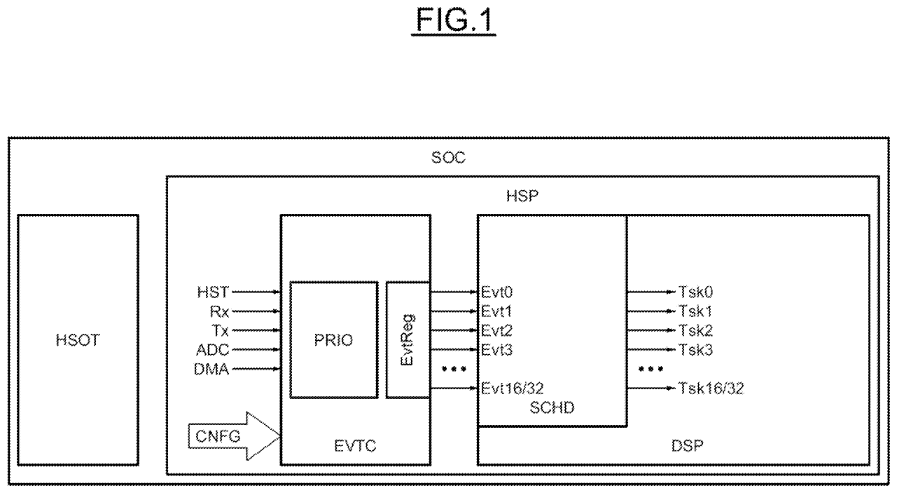

FIG. 1 illustrates an example of an integrated circuit, for example a system on chip SOC such as a microcontroller, including in particular a digital-signal processing unit HSP comprising an event management device EVTC and a digital-signal processor DSP. The system on chip SOC further includes a general-use processor HOST, also called a host processor.

The event management device EVTC is adapted for receiving the trigger signals HST, Rx, Tx, ADC, DMA on input terminals I0, I1, I2, I3, . . . , In, and is configured for associating event data items Evt0, Evt1, Evt2, Evt3, . . . , Evt15/31, respectively with each of the trigger signals HST, Rx, Tx, ADC, DMA.

The trigger signals may be of various natures, i.e. they may for example come from various peripherals of the integrated circuit SOC such as a host processor HOST, a reception stage Rx, a transmission stage Tx, an analogue to digital converter ADC, a direct memory access bus DMA, the digital-signal processor DSP itself, or other conventional peripherals of integrated circuits known to persons skilled in the art.

When one of the trigger signals HST, Rx, Tx, ADC, DMA is received on the respective input terminal Io-In, the event management device EVTC is configured for storing, in an event register EvtReg, the event data item Evt0, Evt1, . . . , Evt15/31 associated with the received trigger signal HST, Rx, Tx, ADC, DMA.

The event data items Evt0-Evt15/31 may be binary words coded in 4 bits making it possible to provide 16 different events (N=15) or in 5 bits making it possible to provide 32 different events (N=31). Other codes may be selected according to the required language and the number of events managed.

The digital-signal processor DSP, or for example in particular a planner (usually a scheduler) SCHD of the digital-signal processor DSP, is configured for associating a respective task Tsk0, Tsk1, Tsk2, Tsk3, . . . , Tsk15/31 with each event data item Evt0-Evt15/31.

The various tasks Tsk0-Tsk15/31 may for example be functions or lists of commands for implementing a processing by the digital-signal processing unit DSP. The processing operations performed by the digital-signal processing unit DSP are for example digital filterings of the finite impulse response (FIR) filter type, calculation operations of multiplications-accumulation, a simple calculation operation of the multiplication type, or other processing operations of variable complexity.

The digital-signal processor DSP is configured for reading the event data item Evt0-Evt15/31 stored in the event register EvtReg, and for executing the task Tsk0-Tsk15/31 associated with said event data item Evt0-Evt15/31.

For example, the digital-signal processor DSP may have an execution state wherein the processor DSP is configured not to react to a reception of an event until it has ended the performance of a current task; and a waiting-for-event state, for example between each execution state, wherein the digital-signal processor DSP is configured to sound out (i.e. to read, for example continuously) the content of the event register EvtReg, optionally including an event data item Evt0-Evt15/31, and, where applicable, immediately performing the associated task Tsk0-Tsk15/31.

Thus, if a trigger signal HST, Rx, Tx, ADC, DMA is received during the waiting-for-event state of the digital-signal processor DSP, then the digital-signal processor DSP detects the event data item Evt0-Evt15/31 in the event register EvtReg, and, via a simple call function, begins to execute the associated task Tsk0-Tsk15/31.

And, if a trigger signal HST, Rx, Tx, ADC, DMA is received during the execution state of the digital signal processor DSP, then the event management device EVTC will store the event data item Evt0-Evt15/31 in the event register EvtReg, and the corresponding task Tsk0-Tsk15/31 is immediately executed at the moment when the digital-signal processor DSP enters the waiting-for-event state.

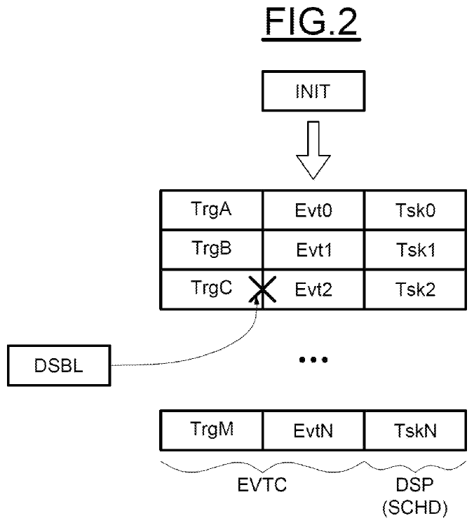

Furthermore, the various event data items Evt0-Evt15/31 can be hierarchised by order of priority, in a way that can be configured for example at each initialisation INIT (FIG. 2) of the digital-signal processing unit HSP, by means of a command CNFG of the host processor HOST.

In this regard reference is made to FIG. 2.

FIG. 2 illustrates schematically the list of associations between the trigger signals TrgA, TrgB, TrgC, . . . , TrgM, and the respective event data items Evt0, Evt1, Evt2, . . . , EvtN; as well as between the event data items Evt0-EvtN and the respective tasks Tsk0, Tsk1, Tsk2, . . . , TskN.

For example, the event management device EVTC is configured by hardware for including, for example in a look-up table (a device usually designated “LUT”), the associations between the trigger signals TrgA-TrgM, coming from respective input terminals, and the respective event data items Evt0-EvtN.

For example, the digital-signal processor DSP, in particular the scheduler (SCHD), is configured by software for providing the associations between the event data items Evt0-EvtN, and the respective tasks Tsk0-TskN, i.e. by a program providing a function of calling each of the tasks Tsk0-TskN, controlled by the corresponding event data item Evt0-EvtN stored in the event register EvtReg.

Thus the event management is configured firstly in the event management device EVTC, and secondly in the digital signal processor DSP.

The event management device EVTC is advantageously adapted for being parameterised, for example during a phase of initialisation INIT of the integrated circuit SOC, by an external command CNFG defining the associations between the event data items and the trigger signals. The external command may come from the host processor HOST and correspond to a use choice of a user. The user may also define, by software in the digital-signal processor DSP, the associations between the tasks to be executed and the event data.

Thus a user of the integrated circuit SOC can fully parameterise the event management according to the application of the integrated circuit SOC and of the digital-signal processor DSP.

Furthermore, the event management device EVTC is advantageously capable of implementing a hierarchised management on reception of the trigger signals TrgA-TrgM by order of priority, so that, in the case of reception of a plurality of trigger signals corresponding to different tasks, it is the task associated with the trigger signal having the greatest importance that is processed.

In this regard, an index “0, 1, 2, . . . , N” is attributed to each event data item Evt0, Evt1, Evt2, . . . , EvtN, so as to represent the priority of the trigger signal TrgA, TrgB, TrgC, . . . , TrgM respectively associated. For example, the index “o” (Evt0) may represent the highest priority while the index “N” (EvtN) may represent the lowest priority.

And the event management device EVTC can be configured so that an event data item of higher priority can replace an event data item of lower priority in the event register EvtReg, while an event data item of lower priority cannot replace an event data item of higher priority in the event register EvtReg.

Consequently, if for example during an execution phase, a trigger signal of higher priority (e.g. TrgB) is received after a trigger signal of lower priority (e.g. TrgC), then the event data item of higher priority (e.g. Evt1) will be able to overwrite the event data item of lower priority (e.g. Evt2) in the event register EvtReg. Conversely, if a trigger signal of lower priority (e.g. TrgC) is received after a trigger signal of higher priority (e.g. TrgB), then the event data item of higher priority (e.g. Evt1) is not overwritten in the event register EvtReg.

Thus, when the digital-signal processor DSP enters the waiting-for-event state, it is the task (e.g. Tsk1) associated with the event data item (e.g. Evt1) stored in the event register EvtReg, and corresponding to the trigger signal of higher priority (e.g. TrgB), that is executed.

Moreover, the event management device EVTC may also be parameterised during the use of the integrated circuit SOC, by means of a deactivation command DSBL. The deactivation command DSBL is for example sent by the host processor HOST. The deactivation command DSBL can make it possible for example to deactivate the effect of one of the trigger signals (e.g. TrgC), by not storing the event data item respectively associated (e.g. Evt2) in the event register EvtReg.

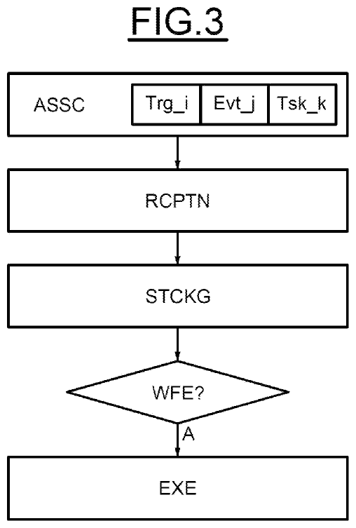

FIG. 3 illustrates an example of an event management method, for example implemented in a signal processing unit HSP as described above in relation to FIGS. 1 and 2.

The method thus comprises an association step ASSC, wherein the event data item Evt_j are respectively associated with the trigger signals Trg_i that can be received on input terminals, for example as parameterised in the event management device EVTC (FIGS. 1 and 2) during a phase of initialisation by an external command; and wherein the tasks Tsk_k are respectively associated with the event data items Evt_j, for example by means of a software configuration of the digital-signal processor DSP (FIGS. 1 and 2).

The method next comprises, for example during an operating phase of the signal processing unit HSP, a step of receiving a trigger signal RCPTN in which a trigger signal HST, Rx, Tx, ADC, DMA (FIG. 1) can be received on one of said input terminals.

In response to the reception of said trigger signal Trg_i, the method comprises a storage of the event data item Evt_j associated with this trigger signal in the event register EvtReg.

The method next comprises an execution EXE of the task Tsk_k associated with the event data item Evt_j stored in the event register. In particular, the execution EXE is implemented if the digital-signal processor DSP (FIGS. 1, 2) of said signal processing unit is in a waiting-for-event state WFE—A (affirmative).

In summary, a user can configure the event management device EVTC, by means of a command CNFG initiated by a host processor HOST. The command CNFG configures the look-up table connecting the trigger signals TrgA-TrgM with the event data items Evt0-EvtN, in a manner making it possible to select the priority of the trigger signals TrgA-TrgM. The user can in parallel define by software the task Tsk0-TskN associated with the respective event data items Evt0-EvtN (connected to the trigger signals).

The look-up table is a set of several tasks programmed during an initialisation phase, so that each task is associated with an event having a respective index that can define a priority. Advantageously, the tasks are awakened only by a respective event, and are not interruptible, so that an executed task is executed to its end. The scheduling of the tasks by the digital-signal processor begins when the look-up table is fully created and includes only one waiting-for-event function “wfe( )” and a call of the function implementing the task.

The following example of a software code of the scheduler SCHD of the digital-signal processor DSP makes it possible, in collaboration with the event management device EVTC, to begin the execution of a task in less than 15 cycles of the clock signal timing the digital-signal processor DSP after reception of the trigger signal:

wfe( )/*waiting for event*/

index=getEvent( );/*reading of the event received*/

ptrTask[index]->function(ptrTask[index]->ptrParam)/*calling of the task*/.

The terms situated between the symbols “/*” and “*/” are comments summarily describing the action of the corresponding code line.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An integrated circuit comprising:
a digital-signal processing unit comprising:
an event management device configured to associate respective event data items with respective trigger signals; and
a digital-signal processor configured to associate a respective task with an respective event data item,
wherein the event management device is configured to:
receive the trigger signals at input terminals; and
when a trigger signal is received, store the event data item associated with the received trigger signal in an event register, and
wherein the digital-signal processor is configured execute the task associated with the event data item stored in the event register.

2. The integrated circuit according to claim 1, wherein the digital-signal processor is configured to execute the task when the digital-signal processor is in a waiting-for-event state.

3. The integrated circuit according to claim 1, wherein the event management device is configured to be parameterised during an initialisation phase by an external command, external to the digital-signal processing unit, defining associations between the event data items and the trigger signals.

4. The integrated circuit according to claim 1, wherein the digital-signal processor is configured by software to:
associate respective tasks with event data items; and
execute the tasks.

5. The integrated circuit according to claim 1, wherein the event management device (EVTC) is configured to place the event data in hierarchical order by order of priority so that an event data item of a lower priority in the event register is replaceable by an event data item of a higher priority, while an event data item of a higher priority in the event register is not replaceable by an event data item of a lower priority.

6. A method for managing events in a signal processing unit, wherein the signal processing unit is able to associate event data items with trigger signals receivable at input terminals and associate tasks with the event data items, the method comprising:
receiving a trigger signal at an input terminal;
storing, in an event register, the event data item associated with the received trigger signal; and
executing the task associated with the event data item stored in the event register.

7. The method according to claim 6, wherein storing, in the event register, the event data item is done in response to receiving the trigger signal.

8. The method according to claim 7, wherein executing the task is done when a digital-signal processor (DSP) of the signal processing unit is in a waiting-for-event state.

9. The method according to claim 6, further comprising associating, by an external command during an initialisation phase, the event data items with the trigger signals thereby defining associations between the event data items and the trigger signals.

10. The method according to claim 6, wherein an association of the tasks with the event data items and the execution of the task associated with the event data item stored in the event register are configured by software in a digital-signal processor (DSP) of the digital signal processing unit.

11. The method according to claim 6, wherein the event data items are placed in hierarchical order by order of priority so that an event data item of a lower priority in the event register is replaceable by an event data item of a higher priority while an event data item of a higher priority in the event register is not replaceable by an event data item of a lower priority.

12. A method comprising:
receiving, by a signal processing unit at an input terminal, a trigger signal;
storing, by the signal processing unit in an event register, an event data item associated with the received trigger signal; and
executing, by the signal processing unit in a digital-signal processor (DSP), a task associated with the event data item stored in the event register,
wherein the signal processing unit includes an association of the event data items with the trigger signals and an association of the tasks with the event data items.

13. The method according to claim 12, wherein the event data item are stored in the event register in response receiving the trigger signal.

14. The method according to claim 13, wherein the task is executed when the digital-signal processor (DSP) is in a waiting-for-event state.

15. The method according to claim 12, wherein the association of the event data items with the trigger signals is defined during an initialisation phase by an external command external to the signal processing unit.

16. The method according to claim 12, wherein an association of a respective tasks with an event data item and an execution of the task associated with the event data item stored in the event register are configured by software in the digital-signal processor (DSP).

17. The method according to claim 12, wherein the event data items are hierarchically ordered by order of priority so that an event data item of a lower priority in the event register is replaceable by an event data item of a higher priority while an event data item of a higher priority in the event register is not replaceable by an event data item of a lower priority.
